(19) United States
(12) Patent Application Publication
(10) Pub. No.: US 2015/0214621 A1
(43) Pub. Date: Jul. 30, 2015

(54) MULTI-BAND PLASMA LOOP ANTENNA

(71) Applicant: Electronics & Telecommunications Research Institute, Daejeon (KR)

(72) Inventors: Cheol Ho KIM, Gunpo-si (KR); Kwang Chun LEE, Daejeon (KR)

(73) Assignee: Electronics & Telecommunications Research Institute, Daejeon (KR)

(21) Appl. No.: 14/604,140

(22) Filed: Jan. 23, 2015

(30) Foreign Application Priority Data
Jan. 24, 2014 (KR) 10-2014-0008775

(51) Int. Cl. H01Q 7/00; H01Q 1/26; H01Q 5/307

(52) U.S. Cl. CPC H01Q 7/00; H01Q 5/307; H01Q 1/26

(57) ABSTRACT

Disclosed is a multi-band plasma loop antenna that may reduce radio interference and provide multiple bands. First, the multi-band plasma loop antenna includes an antenna element including a plurality of plasma loop patterns; a plasma activation controller configured to activate a specific plasma loop pattern among the plurality of plasma loop patterns based on an input signal; and at least one RF feed configured to apply an RF signal to the antenna element. Accordingly, a selective multi-frequency band antenna may be easily implemented, and interference between loops may be minimized. In addition, antenna radiation efficiency may be increased by taking a stacked structure.

### CLAIM FOR PRIORITY

This application claims priority to Korean Patent Application No. 10-2014-0008775 filed on Jan. 24, 2014 in the Korean Intellectual Property Office (KIPO), the entire contents of which are hereby incorporated by reference.

### BACKGROUND

1. Technical Field

Example embodiments of the present invention relate in general to a plasma loop antenna and more specifically to a multi-band plasma loop antenna that may minimize interference and increase antenna gain.

2. Related Art

Generally, an antenna is a device that is provided in a wireless communication terminal (a mobile communication terminal, a Personal Communication Service (PCS) terminal, a Personal Digital Assistant (PDA), a Global positioning system (GPS) terminal, a wireless local area network (LAN) terminal (smartphone)) and configured to receive a reception signal from the outside and emit a transmission signal to the outside.

As such, a wireless communication terminal performs communication by exchanging signals with a call partner terminal through a wireless communication network using an antenna that is positioned at any suitable position inside or outside a main body of the wireless communication terminal and configured to receive or transmit the signals from or to the call partner terminal.

In addition, along with the miniaturizing and lightening trend of a wireless communication terminal, an antenna, which is one of the largest components in the wireless communication terminal, tends to be designed to be small in size in consideration of reception sensitivity, harmfulness of electromagnetic waves, and the like.

For a tube plasma antenna, a gas is converted into plasma that is a conductor having enough ions by containing the gas in a sealed insulation tube and applying an electrical stimulus, and this plasma tube is used as an antenna.

For a solid-state plasma antenna, an electrical or optical stimulus is applied to a desired region of the semiconductor substrate that is a dielectric material as usual for a desired time, and the region is made conductive and used as a feed or a reflective surface of the antenna.

By suitably using conductive variability of the above-described tube plasma antenna and solid-state plasma antenna, conversion of a frequency band of an antenna, adjustment of a direction of a beam, and the like may be more easily implemented, which are generally implemented through a complex structure.

Conventionally, there is a technique in which a plurality of antennas are arranged to function as an antenna in multiple frequency bands. However, the technique has some problems in that radio interference occurs between a plurality of antennas to distort radio waves or decrease strengths of the radio waves.

### SUMMARY

Accordingly, example embodiments of the present invention are provided to substantially obviate one or more problems due to limitations and disadvantages of the related art.

Example embodiments of the present invention provide a multi-band plasma loop antenna that may reduce radio interference and increase an antenna gain.

In some example embodiments, a multi-band plasma loop antenna includes an antenna element including a plurality of plasma loop patterns, a plasma activation controller configured to activate a specific plasma loop pattern among the plurality of plasma loop patterns based on an input signal, and at least one RF feed configured to apply an RF signal to the antenna element.

The antenna element may include a disk-shaped substrate; a plurality of plasma loop patterns formed on the substrate, an interconnection layer formed below the substrate and configured to connect the plurality of plasma loop patterns with the plasma activation controller, an interconnecting pole connected to an end of each of the plurality of plasma loop patterns at one side of the interconnecting pole and connected to the RF feed at the other side, and an insulating layer configured to support the interconnecting pole.

The plurality of plasma loop patterns may be formed of at least one of tube plasma and solid-state plasma.

The plurality of plasma loop patterns may have a shape of at least one of a circle, a rectangle, a triangle, a rhombus, and an ellipse.

The plurality of plasma loop patterns may have different sizes.

In other example embodiments, a multi-band plasma loop antenna includes a first antenna element having a first plasma loop pattern formed therein, a second antenna element combined with a lower surface of the first antenna element and having a second plasma loop pattern formed therein, the second plasma loop pattern having a size corresponding to the first plasma loop pattern, a plasma activation controller configured to activate at least one of the first plasma loop pattern and the second plasma loop pattern based on an input signal, and at least one RF feed configured to perform feeding to the at least one of the first plasma loop pattern and the second plasma loop pattern.

Each of the first antenna element and the second antenna element may include a disk-shaped substrate having a predetermined size, a plurality of plasma loop patterns formed on the substrate, an interconnection layer formed below the substrate and configured to connect the plurality of plasma loop patterns with the plasma activation controller, an interconnecting pole connected to an end of each of the plurality of plasma loop patterns at one side of the interconnecting pole, and an insulating layer configured to support the interconnecting pole.

The multi-band plasma loop antenna may be a multi-loop antenna having one side connected with a ground.

The multi-band plasma loop antenna may be a helical antenna having one open side.

The first plasma loop pattern and the second plasma loop pattern may be formed of at least one of tube plasma and solid-state plasma.

The first plasma loop pattern and the second plasma loop pattern may have a shape of at least one of a circle, a rectangle, a triangle, a rhombus, and an ellipse.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view showing a conventional loop antenna that is seen from a top view;

FIG. 2 is a conceptual view showing a conventional loop antenna that is seen from a side view;

FIG. 3 is a plan view showing a multi-band plasma loop antenna according to an embodiment of the present invention;

FIG. 4 is a side view showing a multi-band plasma loop antenna according to an embodiment of the present invention;

FIG. 5 is a conceptual view showing that a helical structure is modified to a plurality of loops and an interconnecting column;

FIG. 6 is a side view showing a multi-band multi-turn plasma loop antenna according to another embodiment of the present invention; and

FIG. 7 is a side view showing a multi-band helical plasma antenna according to still another embodiment of the present invention.

### DESCRIPTION OF EXAMPLE EMBODIMENTS

The present invention may be variously changed and may have various embodiments. Hereinafter, preferred embodiments of the present invention will be described in detail with reference to the accompanying drawings.

However, it should be understood that the present invention is not limited to these embodiments, and may include any and all modification, variations, equivalents, substitutions and the like within the spirit and scope thereof.

The terms ‘first,’ ‘second,’ and the like may be used to explain various other components, but these components are not limited to the terms. These terms are only used to distinguish one component from another. For example, a first component may be called a second component, and a second component may also be called a first component without departing from the scope of the present invention. The term ‘and/or’ means any one or a combination of a plurality of related and described items.

When it is mentioned that a certain component is “coupled with” or “connected with” another component, it will be understood that the certain component is directly “coupled with” or “connected with” to the other component or a further component may be located therebetween. In contrast, when it is mentioned that a certain component is “directly coupled with” or “directly connected with” another component, it will be understood that a further component is not located therebetween.

The terms used in the present specification are set forth to explain the embodiments of the present invention, and the scope of the present invention is not limited thereto. The singular number includes the plural number as long as they are not apparently different from each other in meaning. In the present specification, it will be understood that the terms “have,” “comprise,” “include,” and the like are used to designate features, figures, steps, operations, components, parts or combination thereof, and do not exclude them.

Unless otherwise defined, all terms (including technical and scientific terms) used herein have the same meaning as commonly understood by one of ordinary skill in the art to which this invention belongs. Terms, such as terms that are generally used and have been in dictionaries, should be construed as having meanings matched with contextual meanings in the art. In this description, unless defined clearly, terms are not ideally, excessively construed as formal meanings.

Hereinafter, preferred embodiments of the present invention will be described in detail with reference to the accompanying drawings. In describing the invention, in order to facilitate the entire understanding of the invention, like numbers refer to like components throughout the description of the figures and the repetitive description thereof will be omitted.

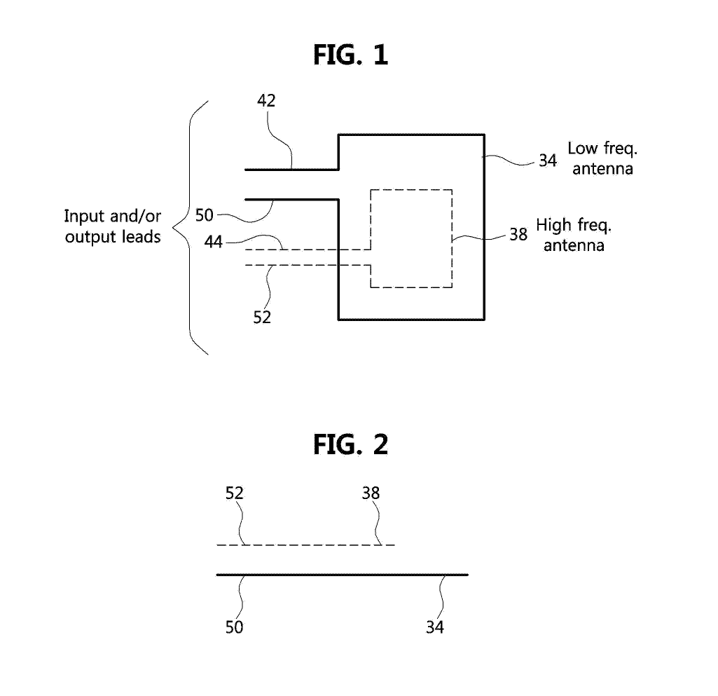

FIG. 1 is a conceptual view showing a conventional loop antenna that is seen from a top view, and FIG. 2 is a conceptual view showing a conventional loop antenna that is seen from a side view.

Referring to FIGS. 1 and 2, when the conventional loop antenna is seen from a top view, a large low-frequency antenna 34 and a small high-frequency antenna 38 are positioned to overlap each other.

In addition, when the conventional loop antenna is seen from a side view, the large low-frequency antenna 34 and the small high-frequency antenna 38 are arranged in parallel and all input/output ports 42, 44, 50, and 52 faces the same side such that the loop antenna may be configured to serve as an antenna in the two frequency regions.

Advantageously, the above loop antenna may select multiple frequency bands. However, due to interference between the radio waves of the large low-frequency antenna 34 and the small high-frequency antenna 38, the loop antenna may distort the radio waves or decrease the strength of the radio waves.

In addition, an increased number of antennas may cause a further increase in interference between the antennas, thus further increasing distortion of the radio waves and decreasing the strength of the radio waves.

In order to solve the above-described program, a multi-band plasma loop antenna according to an embodiment of the present invention will be described below.

Components to be described below are components that are defined not by physical properties but by functional properties. Thus, each component may be defined by its function. Each component may be implemented as hardware and/or a program code and a processing unit for performing its function. The functions of two or more components may be implemented to be included in one component.

Accordingly, it should be noted that names of components in an embodiment to be described below are not given to physically classify the components but given to imply representative functions performed by the components, and the technical spirit of the present invention is not limited by the names of the components.

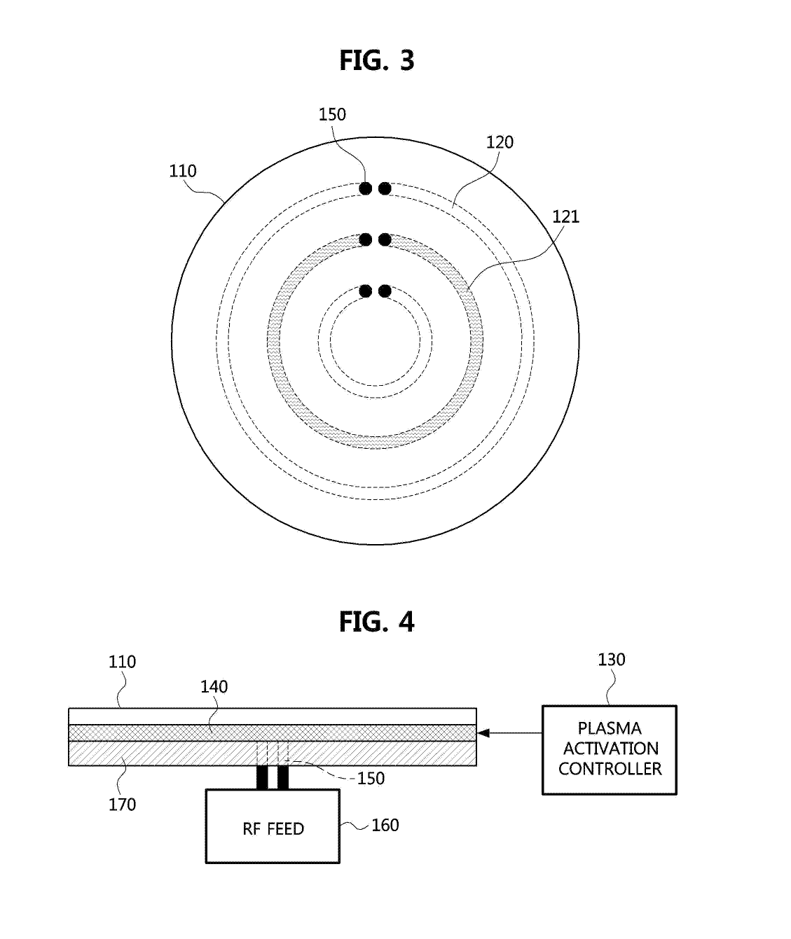

FIG. 3 is a plan view showing a multi-band plasma loop antenna according to an embodiment of the present invention, and FIG. 4 is a side view showing a multi-band plasma loop antenna according to an embodiment of the present invention.

Referring to FIGS. 3 and 4, a multi-band plasma loop antenna 100 according to an embodiment of the present invention may include an antenna element including a plurality of plasma loop patterns, a plasma activation controller 130 configured to activate a specific plasma loop pattern among the plurality of plasma loop patterns, and a RF feed 160 configured to apply an RF signal to the antenna element.

In addition, the antenna element may include a substrate 110, a plurality of plasma loop patterns 120, the plasma activation controller 130, an interconnection layer 140, an interconnecting pole 150, and an insulating layer 170.

The substrate 110 may be a cylindrical disk-like substrate having a predetermined size. Although it is described that the substrate 110 has a disk shape, the shape of the substrate 110 is not limited to the disk shape and may be any of various shapes.

A plurality of plasma loop patterns 120 may be formed in different sizes on the substrate 110. In addition, the plurality of plasma loop patterns 120 may be selectively conductive based on control of the plasma activation controller 130, and may be formed of at least one of tube plasma and solid-state plasma.

Here, the plurality of plasma loop patterns 120 may have the shape of a polygon, such as a circle, a rectangle, a triangle, a rhombus, and an ellipse.

The plasma activation controller 130 may activate a specific plasma loop pattern among the plurality of plasma loop patterns 120 that are connected through the interconnection layer 140 based on an input signal.

Specifically, the plasma activation controller 130 is connected with the plurality of plasma loop patterns through the interconnection layer 140 and configured to control the respective plasma loop patterns such that the specific plasma loop pattern may be activated among the plurality of plasma loop patterns 120 based on an input electrical signal (for example, a DC voltage or current)

The interconnection layer 140 is formed below the substrate 110 such that the plurality of plasma loop patterns 120 and the plasma activation controller 130 are connected with each other.

The interconnecting pole 150 is connected to ends of the respective plasma loop patterns 120 at one side of the interconnecting pole 150 and connected to the RF feed 160 at the other side. For example, each of two interconnecting poles 150 may be connected to ends of the respective plasma loop patterns 120 at one side of the interconnecting pole 150 and connected to the RF feed 160 at the other side.

The RF feed 160 is connected with the interconnecting pole 150 and configured to perform feeding to the specific plasma loop pattern among the plurality of plasma loop patterns through the interconnecting pole 150.

Here, when the RF feed 160 applies an RF signal to the specific plasma loop pattern activated among the plurality of plasma loop patterns, propagation is made through the activated specific plasma loop pattern.

The insulating layer 170 supports the interconnecting pole 150 and is intended for non-conductive physical support. The insulating layer 170 may be omitted when there is no need for the physical support.

With the multi-band plasma loop antenna according to an embodiment of the present invention, radio interference between plasma loop patterns is small because, while a specific loop is activated, the other loops are non-conductive in a deactivated state. In addition, since the plasma activation controller 130 may activate a specific plasma loop pattern among the plurality plasma loop patterns having different sizes, the frequency region may vary depending on the size of the activated plasma loop.

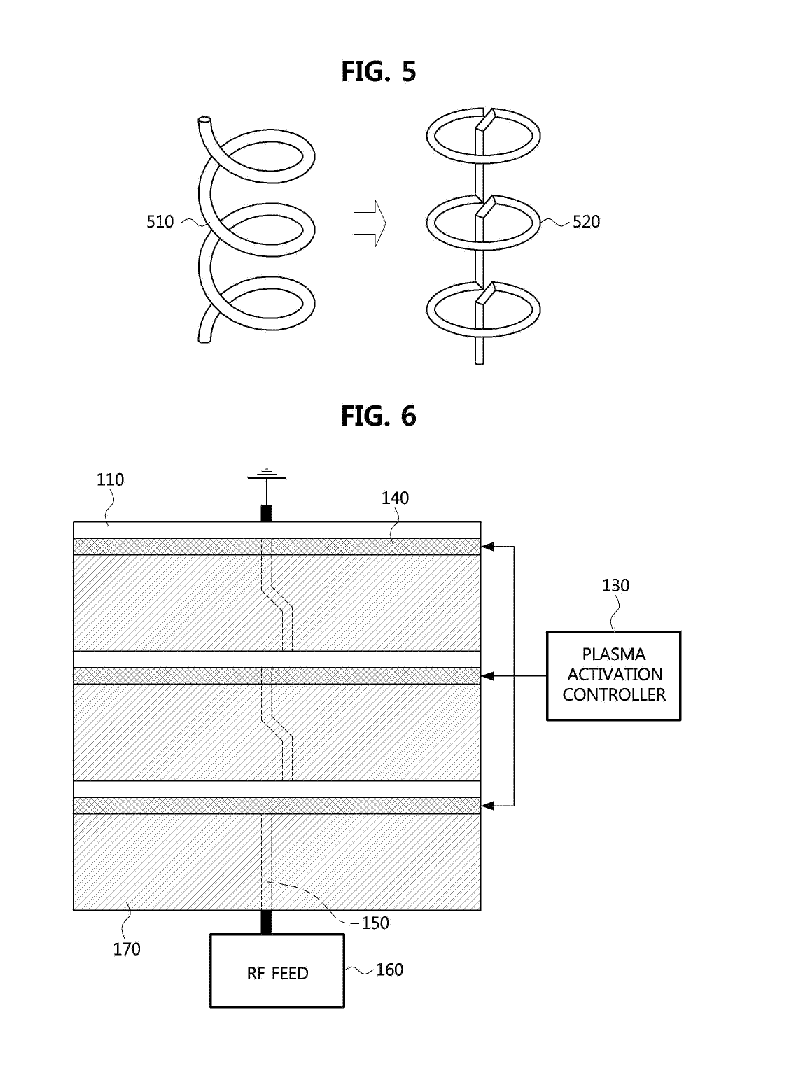

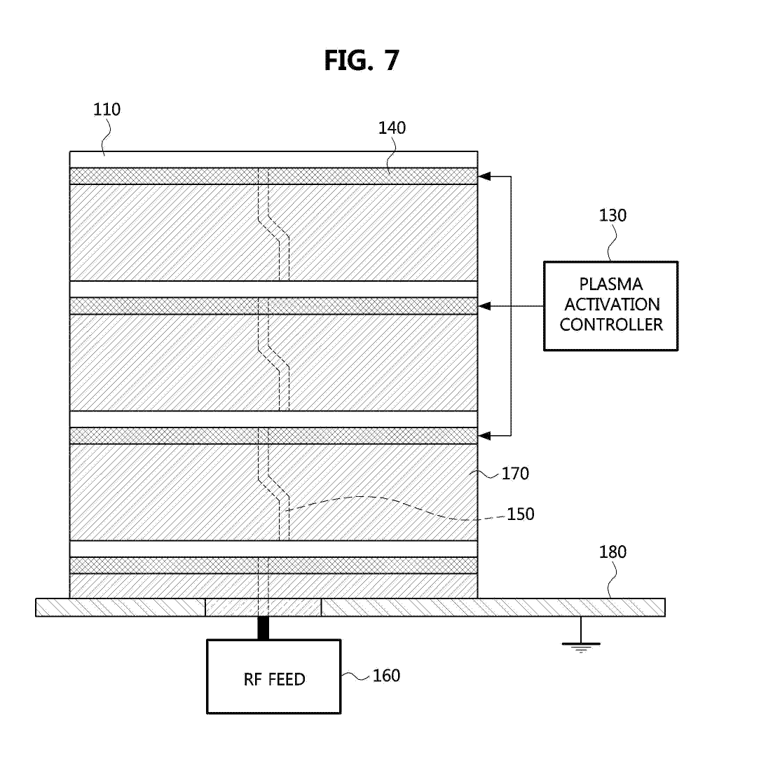

FIG. 5 is a conceptual view showing that a helical structure is modified to a plurality of loops and an interconnecting column, FIG. 6 is a side view showing a multi-band multi-turn plasma loop antenna according to another embodiment of the present invention, and FIG. 7 is a side view showing a multi-band helical plasma antenna according to still another embodiment of the present invention.

The structure shown in FIG. 4 is stacked to form a helical antenna structure that may improve antenna radiation efficiency, which will be described below with reference to drawings.

First, referring to FIG. 5, a helical structure 510 may be modified to a structure 520 having a plurality of loops and an interconnecting column.

That is, referring to FIG. 6, a multi-band multi-turn plasma loop antenna according to another embodiment of the present invention is formed by stacking and combining three antenna elements each having a substrate 110, a plurality of plasma loop patterns (not shown), an interconnection layer 140, an interconnecting pole 150 connected to ends of the plasma loop patterns at one side of the interconnecting pole 150, and an insulating layer 170 configured to support the interconnecting pole 150. Accordingly, a multi-band plasma loop antenna that has more improved antenna radiation efficiency than that of the multi-band plasma loop shown in FIG. 4 may be implemented.

The multi-band multi-turn plasma loop antenna according to another embodiment of the present invention may further include a plasma activation controller 130 configured to control activation of a plasma loop pattern of a specific antenna element and an RF feed 160 configured to perform feeding to the plasma loop pattern through the interconnecting pole 150.

Here, the plasma loop pattern (not shown) may be formed of at least one of tube plasma and solid-state plasma. In addition, the plasma loop pattern (not shown) may have the shape of a polygon, such as a circle, a rectangle, a triangle, a rhombus, and an ellipse.

The multi-band plasma loop antenna of FIG. 6 is a multi-turn loop antenna in which one end of the substrate 110 is connected to the ground.

It has been described that the plasma activation controller 130 may control activation of a specific plasma loop pattern of a specific antenna element among plasma loop patterns included in each of three antenna elements. However, the plasma activation controller 130 may control activation of plasma loop patterns of two antenna elements among the plasma loop patterns included in each of the three antenna elements.

Referring to FIG. 7, a multi-band helical plasma antenna according to still another embodiment of the present invention is formed by stacking four antenna elements each having a substrate 110, a plurality of plasma loop patterns (not shown), an interconnection layer 140, an interconnecting pole 150 connected to ends of the plasma loop patterns at one side of the interconnecting pole 150, and an insulating layer 170 configured to support the interconnecting pole 150. Accordingly, a multi-band plasma loop antenna that has more improved antenna radiation efficiency than that of the multi-band plasma loop shown in FIG. 4 may be implemented.

The multi-band helical plasma antenna according to still another embodiment of the present invention may further include a plasma activation controller 130 configured to control activation of a plasma loop pattern of a specific antenna element among the four antenna elements, an RF feed 160 configured to perform feeding to the plasma loop pattern through the interconnecting pole 150, and a ground plane 180.

Here, it has been described that the plasma activation controller 130 may control activation of a specific plasma loop pattern of a specific antenna element among four antenna elements. However, the plasma activation controller 130 may control activation of plasma loop patterns of two or three antenna elements among the four antenna elements.

In addition, the multi-band plasma loop antenna of FIG. 7 is a helical antenna in which one end of the substrate 110 is open.

With the multi-band plasma loop antenna according to an embodiment of the present invention, radio interference between plasma loop patterns is small because, while a specific loop is activated, the other loops are non-conductive in a deactivated state. Furthermore, the multi-band plasma loop antenna according to an embodiment of the present invention has a stacked structure, which may increase antenna radiation efficiency.

With the multi-band plasma loop antenna according to an embodiment of the present invention, it is possible to position a cylindrical disk-shaped substrate having a predetermined size and a plurality of plasma loop pattern on the substrate, and activate a specific plasma loop pattern among the plurality of plasma loop patterns.

Accordingly, a selective multi-frequency band antenna may be easily implemented, and interference between loops may be minimized. In addition, an antenna having the increased radiation efficiency may be implemented by taking a stacked structure.

While the example embodiments of the present invention and their advantages have been described in detail, it should be understood that various changes, substitutions and alterations may be made herein without departing from the scope of the invention.

What is claimed is:

1. A multi-band plasma loop antenna comprising:
an antenna element including a plurality of plasma loop patterns;
a plasma activation controller configured to activate a specific plasma loop pattern among the plurality of plasma loop patterns based on an input signal; and
at least one RF feed configured to apply an RF signal to the antenna element.

2. The multi-band plasma loop antenna of claim 1, wherein the antenna element comprises:
a substrate;
a plurality of plasma loop patterns formed on the substrate;
an interconnection layer formed below the substrate and configured to connect the plurality of plasma loop patterns with the plasma activation controller;
an interconnecting pole connected to an end of each of the plurality of plasma loop patterns at one side of the interconnecting pole and connected to the RF feed at the other side; and
an insulating layer formed below the connection layer and configured to support the interconnecting pole.

3. The multi-band plasma loop antenna of claim 1, wherein the plurality of plasma loop patterns are formed of at least one of tube plasma and solid-state plasma.

4. The multi-band plasma loop antenna of claim 1, wherein the plurality of plasma loop patterns have a shape of at least one of a circle, a rectangle, a triangle, a rhombus, and an ellipse.

5. The multi-band plasma loop antenna of claim 1, wherein the plurality of plasma loop patterns have different sizes.

6. A multi-band plasma loop antenna comprising:
a first antenna element having a first plasma loop pattern formed therein;
a second antenna element combined with a lower surface of the first antenna element and having a second plasma loop pattern formed therein, the second plasma loop pattern having a size corresponding to the first plasma loop pattern;
a plasma activation controller configured to activate at least one of the first plasma loop pattern and the second plasma loop pattern based on an input signal; and
at least one RF feed configured to perform feeding to the at least one of the first plasma loop pattern and the second plasma loop pattern.

7. The multi-band plasma loop antenna of claim 6, wherein each of the first antenna element and the second antenna element comprises:
a substrate having a predetermined size;
a plurality of plasma loop patterns formed on the substrate;
an interconnection layer formed below the substrate and configured to connect the plurality of plasma loop patterns with the plasma activation controller;
an interconnecting pole connected to an end of each of the plurality of plasma loop patterns at one side of the interconnecting pole; and
an insulating layer configured to support the interconnecting pole.

8. The multi-band plasma loop antenna of claim 6, wherein the multi-band plasma loop antenna is a multi-loop antenna having one side connected with a ground.

9. The multi-band plasma loop antenna of claim 6, wherein the multi-band plasma loop antenna is a helical antenna having one open side.

10. The multi-band plasma loop antenna of claim 6, wherein the first plasma loop pattern and the second plasma loop pattern are formed of at least one of tube plasma and solid-state plasma.

11. The multi-band plasma loop antenna of claim 6, wherein the first plasma loop pattern and the second plasma loop pattern have a shape of at least one of a circle, a rectangle, a triangle, a rhombus, and an ellipse.
